(19) United States
(12) Patent Application Publication
(10) Pub. No.: US 2024/0279452 A1
(43) Pub. Date: Aug. 22, 2024

(54) HIGH TEMPERATURE BLASTING RESISTANCE ISOTACTIC POLYBUTENE ALLOY AND PREPARATION METHOD THEREOF

(71) Applicant: QINGDAO UNIVERSITY OF SCIENCE AND TECHNOLOGY, Qingdao (CN)

(72) Inventors: Aihua HE, Qingdao (CN); Chenguang LIU, Qingdao (CN); Huafeng SHAO, Qingdao (CN)

(73) Assignee: QINGDAO UNIVERSITY OF SCIENCE AND TECHNOLOGY, Qingdao (CN)

(21) Appl. No.: 18/648,964

(22) Filed: Apr. 29, 2024

Related U.S. Application Data
(63) Continuation of application No. PCT/CN2023/097015, filed on May 30, 2023.

(30) Foreign Application Priority Data
Jun. 10, 2022 (CN) 202210655842.5

(51) Int. Cl. C08L 23/22; C08F 2/01; C08F 2/06; C08F 4/659; C08F 210/08

(52) U.S. Cl. CPC C08L 23/22; C08F 2/01; C08F 2/06; C08F 4/65912; C08F 210/08; C08F 2400/02; C08F 2800/20; C08L 2205/025; C08L 2205/035; C08L 2207/10

(57) ABSTRACT

Disclosed are a high temperature blasting resistance isotactic polybutene alloy and a preparation method thereof. The isotactic polybutene alloy of the present invention comprises 1-40% of isotactic polypropylene in parts by mass, 0.1-10% of a polypropylene-polybutene-1 block copolymer in parts by mass, 35-95.9% of isotactic polybutene-1 of a medium molecular weight in parts by mass, and 3-15% of isotactic polybutene-1 of a high molecular weight in parts by mass. The alloy material is prepared using a method of segmented polymerization of propylene polymerization, high hydrogen content butene polymerization and low hydrogen content butene polymerization. The prepared isotactic polybutene alloy has excellent high temperature blasting resistance and high temperature hydrostatic pressure, is high in vicat softening temperature, and is applicable to pressure pipes.

### CROSS-REFERENCE TO RELATED APPLICATIONS

This application is a continuation of International Application No. PCT/CN2023/097015, filed on May 30, 2023, which claims priority to Chinese Patent Application No. 202210655842.5, filed on Jun. 10, 2022. All of the aforementioned applications are incorporated herein by reference in their entireties.

### TECHNICAL FIELD

The present invention belongs to the technical field of novel polyolefin materials, and in particular relates to a high temperature blasting resistance isotactic polybutene alloy and a preparation method thereof.

### BACKGROUND

High-isotacticity polybutene-1 (iPB) has excellent impact resistance, outstanding high-temperature creep resistance and stress cracking resistance, but lower rigidity, therefore, on the basis of maintaining the excellent properties of polybutene-1, the application field of polybutene-1 can be widened by improving the rigidity and heat resistance thereof.

The Chinese Patent Publication CN1220727C claims a polybutene-1 resin composition prepared from butene-1, a copolymer of butene-1 and advanced alpha-olefin, and a polypropylene resin composition in a physical blending mode of melt kneading, which can be used in the field of cold/hot water pipes and pipe fittings. The Chinese Patent Publication CN102268160B claims a novel isotactic polybutene alloy. The isotactic polybutene alloy, on premise of not affecting the high-temperature creep resistance and flexibility of polybutene-1 resin, shortens the molding cycle as much as possible, and improves the strength, modulus, and the like thereof. The Chinese Patent Publication CN102838807B discloses a polypropylene composite material with good impact resistance and low-temperature toughness and a preparation method thereof. The matrix resin of the composite material consists of 30-80% of polypropylene in mass content and 10-40% of a low-density low-melt index polyolefin elastomer in mass content, being good in processing performance, size stability and low-temperature performance. The Chinese Patent Application Publication CN111440387A provides an isotactic polybutene alloy with high rigidity and good heat resistance, and a preparation method thereof. The patents above all adopt methods of physical blending or fill blending modification to improve properties of polybutene-1 materials. However, generally mixing of a smaller scale or even at the molecular level cannot be achieved by means of physical blending, not to mention the problem of poor phase interface adhesion.

In-situ preparation of a polypropylene alloy in a kettle can not only effectively improve the dispersion of alloy components, but also significantly improve the phase interface of the alloy by in-situ synthesis of a small amount of copolymers. The Qingdao University of Science and Technology (Chinese Patent Application Publication CN104628913 A) discloses a method for preparing an isotactic polybutene alloy by dissolving butene-1 and propylene in an aromatic organic solvent through fractional solution polymerization. Multi-component structures in the alloy achieve uniform mixing at the molecular level under the action of the organic solvent, endowing the prepared alloy material with good impact resistance and toughness. The Chinese Patent Publication CN102268160B discloses an isotactic polybutene alloy and a preparation method thereof. The alloy contains 50-99% of identical polybutene-1 in mass content, 1-40% of identical polypropylene in mass content and 0-10% of a propylene-butene-1 random copolymer. However, no synthesis of polybutene-1 materials with heat resistance and blasting resistance is involved.

### SUMMARY

For the problems mentioned above and in the present technical schemes, one of the purposes of the present invention is to provide a high temperature blasting resistance isotactic polybutene alloy.

A second purpose of the present invention is to provide a preparation method of the high temperature blasting resistance isotactic polybutene alloy.

According to the present invention, an isotactic polybutene alloy is prepared from a heterogeneous supported titanium catalyst by using a fractional step method, namely first preparing isotactic polybutene-1 through propylene slurry or bulk polymerization; secondly carrying out butene-1 polymerization on polypropylene granules, to obtain isotactic polybutene-1 of a medium molecular weight by adjusting the hydrogen volume; and finally carrying out butene-1 polymerization, to obtain isotactic polybutene-1 of a high molecular weight greater than 1 million by reducing the hydrogen volume, thereby obtaining the isotactic polybutene alloy through in-situ synthesis. Or first carrying out butene-1 polymerization to obtain isotactic polybutene-1 of the medium molecular weight; secondly reducing the hydrogen volume, and continuing butene-1 polymerization to obtain isotactic polybutene-1 of the high molecular weight greater than 1 million; and finally carrying out propylene bulk polymerization, thereby obtaining isotactic polypropylene.

The high temperature blasting resistance isotactic polybutene alloy of the present invention includes 1-40% of isotactic polypropylene in parts by mass, 0.1-10% of a polypropylene-polybutene-1 block copolymer in parts by mass, 35-95.9% of isotactic polybutene-1 of a medium molecular weight in parts by mass, and 3-15% of isotactic polybutene-1 of a high molecular weight in parts by mass.

The weight-average molecular weight of the isotactic polybutene-1 of the medium molecular weight in the isotactic polybutene alloy of the present invention is 0.2-1 million, and the weight-average molecular weight of the isotactic polybutene-1 of the high molecular weight is 1.1-2 million.

The weight-average molecular weight of the isotactic polypropylene in the isotactic polybutene alloy of the present invention is 0.2-0.8 million, with the isotacticity greater than 95%; the isotacticity of the isotactic polybutene-1 is greater than 95%; the isotacticity of the polypropylene-polybutene-1 block copolymer is greater than 95%; and the mole content of a propylene unit in the block copolymer is 40-70%.

The present invention provides a preparation method I of the high temperature blasting resistance isotactic polybutene alloy, including the following steps.

(1) Carrying out pump drainage with a polymerization reactor and high-purity nitrogen replacement for times, and sequentially adding propylene and/or an inert solvent with 5-10 carbon atoms, aluminium alkyl, an external donor, a supported titanium catalyst and hydrogen into the polymerization reactor by using a mass flowmeter, where the mass ratio of the propylene to the inert solvent is 1:(0-100), the mole ratio of the propylene to the titanium element in the supported titanium catalyst is (0.001*10⁸-1*10⁸):1, the mole ratio of the aluminium element in the aluminium alkyl to the titanium element in the supported titanium catalyst is (10-200):1, the mole ratio of the external donor to the titanium element is (5-25):1, the mole ratio of the hydrogen to the propylene is 1:(50-600), the polymerization temperature is controlled to 0-80° C., the stirring rotation speed is 5-500 rpm, and the polymerization time is 0.01-3 h, thereby carrying out propylene polymerization.

(2) When the polymerization time of the reaction system reaches any time point of the 0.01-3 h, depressurizing to remove remaining propylene monomer, hydrogen or/and inert solvent, so as to obtain active polypropylene granules.

(3) Sequentially adding butene-1, aluminium alkyl and hydrogen into the polymerization reactor with the active polypropylene granules, where the mole ratio of butene-1 to the titanium element in the supported titanium catalyst is (0.001*10⁷-1*10⁷):1, the mole ratio of the aluminium element to the titanium element in the supported titanium catalyst is (10-200):1, the mole ratio of hydrogen to butene-1 is 1:(700-1300), the polymerization time is 0.1-2 h, and the polymerization temperature is 0-60° C.

(4) When the polymerization time of the reaction system reaches any time point of the 0.1-2 h, adding hydrogen into the polymerization reactor, where the mole ratio of hydrogen to butene-1 is 1:(100-600), the polymerization time is 0.1-46 h, and the polymerization temperature is 0-60° C.

(5) When the polymerization time of the reaction system reaches any time point of the 0.1-46 h, depressurizing to remove unreacted butene-1 monomer and hydrogen, thereby obtaining the isotactic polybutene alloy.

The present invention provides a preparation method II of the high temperature blasting resistance isotactic polybutene alloy, including the following steps.

(1) Carrying out pump drainage with a polymerization reactor and high-purity nitrogen replacement for times, and sequentially adding butene-1, aluminium alkyl, an external donor, a supported titanium catalyst and hydrogen into the polymerization reactor by using a mass flowmeter, where the mole ratio of the butene-1 to the titanium element in the supported titanium catalyst is (0.001*10⁸-1*10⁸):1, the mole ratio of the aluminium element to the titanium element in the supported titanium catalyst is (10-500):1, the mole ratio of the external donor to the titanium element is (5-25):1, the mole ratio of the hydrogen to the butene-1 is 1:(100-600), the polymerization temperature is controlled to 0-40° C., the stirring rotation speed is 5-500 rpm, and the polymerization time is 0.1-46 h.

(2) When the polymerization time of the reaction system reaches any time point of the 0.1-46 h, adding a butene-1 monomer into the polymerization reactor, and regulating the mole ratio of hydrogen to butene-1 to 1:(700-1300), the polymerization time to 0.1-2 h, and the polymerization temperature to 0-60° C.

(3) When the polymerization time of the reaction system reaches any time point of the 0.1-2 h, depressurizing to remove unreacted butene-1 and hydrogen, so as to obtain active polybutene-1 granules.

(4) Sequentially adding propylene, aluminium alkyl and hydrogen into the polymerization reactor, where the mole ratio of propylene to the titanium element in the supported titanium catalyst is (0.001*10⁸-1*10⁸):1, the mole ratio of the aluminium element in the aluminium alkyl to the titanium element in the supported titanium catalyst is (0-100):1, the mole ratio of hydrogen to propylene is 1:(50-600), the polymerization temperature is controlled to 0-80° C., the stirring rotation speed is 5-500 rpm, and the polymerization time is 0.01-3 h.

(5) When the polymerization time of the reaction system reaches any time point of the 0.01-3 h, depressurizing to remove unreacted monomers and hydrogen, thereby obtaining the isotactic polybutene alloy.

In the preparation method of isotactic polybutene alloy, aluminium alkyl is a mixture of triethylaluminium (TEA) and triisobutylaluminium, diethylaluminium hydride, diisobutylaluminium, dimethylaluminum chloride, diethylaluminum chloride and diisobutylaluminum chloride, the mass content of triethylaluminium (TEA) in the mixture is 80-100%, and the volume ratio of the inert solvent to propylene is (0-100):1.

The inert solvent is selected from one or more of pentane, isopentane, hexane, cyclohexane, methyl cyclohexane, n-heptane, n-heptane, n-octane, benzene, methyl benzene, p-xylene, m-xylene, isopropylbenzene, hydrogenated gasoline and raffinate oil.

In the preparation method of the isotactic polybutene alloy, the titanium element in the supported titanium catalyst accounts for 1-5% of the total mass of the supported titanium catalyst, and the internal electron donor accounts for 0.5-20% of the total mass of the supported titanium catalyst; one of magnesium chloride, magnesium bromide, magnesium iodide or silicon dioxide is adopted as the supporter for the supporting; and the external donor is one or more of cyclohexyl trimethoxy silane, tert-butyl trimethoxy silane, tert-hexyl trimethoxy silane, diisopropyl dimethoxy silane, cyclohexyl dimethoxy methyl silane, diphenyl dimethoxy silane, tert-butyl-methoxy-dimethyl silane, dimethoxy dicyclopentyl silane, 2-ethyl piperidyl-2-tert-butyl dimethoxy silane, 1,1,1-trifluoropropyl-2-ethyl piperidyl-dimethoxy silane, ethyl trimethoxy silane, trimethoxy propyl silane, phenyl trimethoxy silane and dicyclohexyl dimethoxy silane.

In the reparation method of the isotactic polybutene alloy, titanium is one of titanium tetrachloride, titanium tetrabromide or titanium tetraiodide containing titanium elements; and the internal electron donor is one or more of benzoic acid, p-methoxybenzoic acid, p-ethoxybenxoic acid, phenylacetic acid, diisobutyl phthalate, dibutyl phthalate, benzoquinone, methyl benzoate, ethyl benzoate and 9,9-bi(methoxy-methyl) fluorene.

In the reparation method of the isotactic polybutene alloy, the polymerization reactor is equipped with a gas phase reflux unit, for cooling and turning back an upper-layer gas to the liquid phase system of the polymerization reactor; the stirring shaft and blades of the polymerization reactor are equipped with hydrogen feeding pipelines and vents, to disperse a gas phase at the upper part of the polymerization reactor into a liquid phase through the pipelines and vents, thereby maintaining homogeneous distribution of the hydrogen concentration of the whole polymerization system.

In the isotactic polybutene alloy of the present invention, the isotactic polybutene-1 of the high molecular weight is used for improving the high temperature blasting resistance and high temperature hydrostatic resistance of the isotactic polybutene alloy. The isotactic polybutene alloy has a vicat softening temperature of 115-120° C. tested using an A50 method, and the blasting pressure of a isotactic polybutene alloy tube prepared therefrom, tested at 20 and 95° C., is higher than that of a polybutene-1 tube. The product has a longitudinal shrinkage ratio of 0.2-0.4%, being superior to the polybutene-1 tube. The creep test result shows that the creep value of the isotactic polybutene alloy is only 62-65% of that of the polybutene-1 tube for the creep time of 4 h, at the ambient temperature of 95° C., and under the test stress of 8 MPa.

The present invention has the beneficial effects as follows.

The present invention relates to the high temperature blasting resistance isotactic polybutene alloy. The isotactic polybutene alloy includes 1-40% of isotactic polypropylene in parts by mass, 0.1-10% of the polypropylene-polybutene-1 block copolymer in parts by mass, 35-95.9% of isotactic polybutene-1 of the medium molecular weight with the weight-average molecular weight of 0.2-1 million in parts by mass, and 3-15% of isotactic polybutene-1 of the high molecular weight with the weight-average molecular weight of 1.1-2 million in parts by mass. As a novel polyolefin material.

The high temperature blasting resistance isotactic polybutene alloy of the present invention has the following characteristics.

Firstly, according to the present invention, the isotactic polybutene alloy is prepared by using a method of multistage polymerization, namely a stage of propylene polymerization reaction, a stage of butene-1 polymerization with a high hydrogen volume and a stage of butene-1 polymerization with a low hydrogen volume, thereby obtaining the isotactic polybutene alloy containing the isotactic polypropylene, the polypropylene-polybutene-1 block copolymer, the isotactic polybutene-1 of the medium molecular weight and the isotactic polybutene-1 of the high molecular weight.

Secondly, in the isotactic polybutene alloy of the present invention, by controlling two stages of butene-1 polymerization under different hydrogen volume conditions, the isotactic polybutene alloy containing isotactic polybutene-1 of the high molecular weight is obtained, and the presence of the isotactic polybutene-1 of the high molecular weight provides excellent high temperature blasting resistance and high temperature hydrostatic resistance to the isotactic polybutene alloy.

Lastly, in the polymerization process of the present invention, due to adoption of a hydrogen distribution device, uniform distribution of hydrogen of the polymerization system is achieved, and the isotactic polybutene alloy with uniform distribution of molecular weights is further obtained.

### DETAILED DESCRIPTION OF THE EMBODIMENTS

The present invention is further described below with specific examples. It should be understood that these examples are used only to illustrate the present invention and do not limit the scope of the present invention. In addition, it should be understood that after reading the content of the present invention, those skilled in the field can make changes or modifications to the present invention, and these equivalent forms also fall within the scope of the claims attached to the present application.

Unless otherwise specified, methods and equipment used in the present invention are conventional methods and equipment in the field.

Relevant test conditions involved in the examples are as follows.

Isotacticity: represented by weight percent of undissolved substances after 48 h of extraction with ether.

Vicat softening temperature: tested according to GB/T 1633-2000, with a load of 10N, and a heating temperature of 50° C./h.

Longitudinal shrinkage ratio of pipes: tested with the longitudinal recovery rate of pipes, namely according to GB/T 6671-2001, taking three 200 mm test samples, drawing two circumferences in a distance of 100 mm at least 10 mm away from both ends of a pipe, adjusting the temperature of an oven to 110° C., putting the test samples into the oven (the samples do not touch the bottom and walls of the oven), maintaining for 60 min, taking out the test samples, cooling to 23° C., measuring the distance L between marking lines, calculating longitudinal recovery rates R=|L0−L|/L0 of the samples, and calculating the arithmetic mean value of three test samples R, as the longitudinal recovery rate of the pipes.

Pipe blasting test: according to GB/T 15560, selecting pipes of 300 mm to test the hydraulic instantaneous burst performance of the pipes, at the test temperatures of 20° C. and 95° C. respectively, with 3 pipes for parallel test.

Pipe hydrostatic test: according to GB/T 19473.2-2004, testing the hydrostatic performance of a pipe, namely cutting an extruded pipe (3 sections) of 250 mm, and adjusting the processed pipe for about 1 h in a test environment, under the experimental condition as shown in Table 1.

TABLE 1
Hydrostatic test conditions of pipe

| | | Induced | Test temperature | Test |
|---|---|---|---|---|
| Test item | Requirement | stress (MPa) | (° C.) | time (h) |
| Hydrostatic | No leakage | 15.5 | 20 | 1 |
| test | No crack | 6.5 | 95 | 22 |
| | | 6.2 | 95 | 165 |
| | | 6.0 | 95 | 1000 |

To rapidly screen and enhance comparison between different materials, hydrostatic reinforced testing designed by a laboratory self is adopted for the hydrostatic test, namely if there is no crack or leakage after the normal temperature hydrostatic pressure of 15.5 Mpa is maintained for 2 h, adding a ring stress of 0.5 Mpa, and if there is no leakage or crack after 2 h, repeating the step; and there is no crack or leakage after the hydrostatic pressure of 6.5 MPa at 95° C. is maintained for 22 h, adding a ring stress of 0.5 MPa, and if there is no leakage or crack after 2 h, repeating the step.

High-temperature creep resistance test: testing the high-temperature creep resistance of a pipe through dynamic mechanical analysis (DMA), for the creep time of 4 h, at the ambient temperature of 95° C., and under the test stress of 8 MPa.

Pipe processing parameters: carrying out pipe extrusion by using a laboratory small-size single screw extruder, to prepare an S10 PB pipe meeting requirements of GB/T 19473.2, where the outer diameter of the pipe is 20.4±0.1 mm, and the wall thickness of the pipe is 1.30±0.10 mm.

### Example 1

After vacuum pump drainage with a 10 L stainless steel pressure polymerizing pot, and high-purity nitrogen replacement for times, replacement with a propylene monomer was further carried out twice, triethylaluminium (TEA) (Al), an external donor diphenyldimethoxy silane (Si) and 2.0 g of a MgCl₂ supported TiCl₄ catalyst (the Ti content was 2.8 wt %) were sequentially measured and added into the polymerizing pot, where Al/Ti=10 (in mole ratio), Si/Ti=25 (in mole ratio), 1 L of hydrogen was added, 10 L of propylene was continuously introduced into the polymerizing pot through a gas phase feeder, the stirring rotation speed was controlled to 500 rpm to polymerize at 40° C. for 2 h, and subsequently cooling and exhausting of propylene and hydrogen were carried out. First-stage polymerization of butene-1: 2.0 Kg of butene-1 was added into the polymerizing pot, 36 g of hydrogen was added, triethylaluminium (TEA) was supplemented to achieve Al/Ti=100 (in mole ratio) to react at 40° C. for 48 h, and subsequently cooling and exhausting of butene-1 and hydrogen were carried out. Second-stage polymerization of butene-1: 1.0 Kg of butene-1 was added into the polymerizing pot to react at 40° C. for 2 h, and drying was terminated to directly obtain a powered isotactic polybutene alloy. Properties of the alloy are shown in Table 2.

### Example 2

Except that the propylene volume was 5 L and 1.5 L of hydrogen were added in propylene polymerization, and in second-stage polymerization of butene-1, 3.6 g of hydrogen was introduced to react at 40° C. for 1 h, others were identical to those of Example 1. Properties of the alloy are shown in Table 2.

### Example 3

After vacuum pump drainage with a 20 L stainless steel pressure polymerizing pot, and high-purity nitrogen replacement for times, replacement with a butene-1 monomer was further carried out twice, 7.5 Kg of butene-1, triethylaluminium (TEA) (Al), tert-hexyl trimethoxy silane (Si) and 0.2 g of an SiO₂ supported TiCl₄ catalyst (the Ti content was 3.2 wt %) were sequentially measured and added into the polymerizing pot, where Al/Ti=150 (in mole ratio), Si/Ti=5 (in mole ratio), 5 g of hydrogen was added, the stirring rotation speed was controlled to 400 rpm to polymerize at 15° C. for 1 h, subsequently 30 g of hydrogen was added to continuously polymerize for 40 h, and cooling and exhausting of butene-1 and hydrogen were carried out. 5 L of propylene was added into the polymerizing pot, 4 g of hydrogen was added to react at 80° C. for 0.5 h, and subsequently cooling and exhausting of butene-1 and hydrogen were carried out. Drying was terminated to directly obtain a powered isotactic polybutene alloy. Properties of the alloy are shown in Table 2.

### Example 4

After vacuum pump drainage with a 10 L stainless steel pressure polymerizing pot, and high-purity nitrogen replacement for times, replacement with a propylene monomer was further carried out twice, triethylaluminium (TEA) (Al), an external donor diphenyldimethoxy silane (Si) and 2.0 g of a MgCl₂ supported TiCl₄ catalyst (the Ti content was 2.8 wt %) were sequentially measured and added into the polymerizing pot, where Al/Ti=10 (in mole ratio), Si/Ti=25 (in mole ratio), 1 L of hydrogen was added, 10 L of propylene was continuously introduced into the polymerizing pot through a gas phase feeder, the stirring rotation speed was controlled to 500 rpm to polymerize at 40° C. for 2 h, and subsequently cooling and exhausting of propylene and hydrogen were carried out. First-stage polymerization of butene-1: 2.0 Kg of butene-1 was added into the polymerizing pot, 36 g of hydrogen was added, triethylaluminium (TEA) was supplemented to achieve Al/Ti=100 (in mole ratio) to react at 40° C. for 48 h, and subsequently cooling and exhausting of butene-1 and hydrogen were carried out. Drying was terminated to directly obtain a powered isotactic polybutene alloy. Properties of the alloy are shown in Table 2.

### Comparative Example 1

After vacuum pump drainage with a 20 L stainless steel pressure polymerizing pot, and high-purity nitrogen replacement for times, replacement with a butene-1 monomer was further carried out twice, and 7.5 Kg of butene-1, triethylaluminium (TEA) (Al), tert-hexyl trimethoxy silane (Si) and 0.2 g of an MgCl₂ supported TiCl₄ catalyst (the Ti content was 3.2 wt %) were sequentially measured and added into the polymerizing pot, where Al/Ti=150 (in mole ratio), and Si/Ti=5 (in mole ratio), 35 g of hydrogen was added, the stirring rotation speed was controlled to 400 rpm to polymerize at 15-40° C. for 48 h, and subsequently cooling and exhausting of butene-1 and hydrogen were carried out. Drying was terminated to directly obtain a powered homopolymerized polybutene-1 material. Properties of the alloy are shown in Table 2.

TABLE 2
Properties of polymers obtained in examples

| | | | | | | Comparative |
|---|---|---|---|---|---|---|
| | | Example | Example | Example | Example | example |
| Item | | 1 | 2 | 3 | 4 | 1 |
| Content of isotactic | | 15 | 8 | 9.3 | 6 | 0 |
| polypropylene/wt % | | | | | | |
| Molecular weight | | 62 | 43 | 68 | 68 | 0 |
| of isotactic | | | | | | |
| polypropylene/10⁴ | | | | | | |
| Content of block | | 10 | 7.5 | 4.5 | 5.6 | 0 |
| copolymer/wt % | | | | | | |
| isotactic | Content of | 72 | 74.5 | 81.2 | 88.4 | 98 |
| poly | polybutene-1 | | | | | |
| butene-1 | of medium | | | | | |
| | molecular | | | | | |
| | weight/wt % | | | | | |
| | Molecular | 68 | 66 | 67 | 65.3 | 69.5 |
| | weight of | | | | | |
| | polybutene-1 | | | | | |
| | of medium | | | | | |
| | molecular | | | | | |
| | weight/10⁴ | | | | | |
| | Content of | 3 | 10 | 5 | 0 | 0 |
| | polybutene-1 | | | | | |
| | of high | | | | | |
| | molecular | | | | | |
| | weight/wt % | | | | | |
| | Molecular | 142 | 108 | 130 | 0 | 0 |
| | weight of | | | | | |
| | polybutene-1 | | | | | |
| | of high | | | | | |
| | molecular | | | | | |
| | weight/10⁴ | | | | | |

| | | | | | |
|---|---|---|---|---|---|
| Vicat softening | 120 | 120 | 120 | 117 | 106 |
| temperature/° C. | | | | | |
| Burst pressure at | 2.80 ± 0.04 | 2.75 ± 0.03 | 2.95 ± 0.08 | 2.54 ± 0.02 | 2.19 ± 0.02 |
| 20° C./MPa | | | | | |
| Burst pressure at | 1.09 ± 0.03 | 1.12 ± 0.02 | 1.08 ± 0.01 | 1.08 ± 0.02 | 0.80 ± 0.03 |
| 95° C./MPa | | | | | |
| Longitudinal | 0.2 | 0.4 | 0.3 | 0.2 | 0.1 |
| shrinkage ratio/% | | | | | |
| Creep/% | 4.65 | 4.47 | 4.67 | 4.68 | 7.2 |
| Hydrostatic resistance/ | 19.5 MPa | 18.5 MPa | 19.5 MPa | 18.5 MPa | 15.5 MPa |
| passing pressure | | | | | |
| at 20° C. | | | | | |
| Hydrostatic resistance/ | 8.5 MPa | 8.0 MPa | 8.5 MPa | 8.0 MPa | Not passed |
| passing pressure | | | | | |
| at 95° C. | | | | | |

The examples of the disclosure are intended to embrace all such alternatives, modifications, and variations as to fall within the broad scope of the appended claims. Therefore, any omission, modification, equivalent replacement and improvement made within the spirits and principles of the examples of the present disclosure shall fall within the protection scope of the present disclosure.

What is claimed is:

1. A high temperature blasting resistance isotactic polybutene alloy, comprising 1-40% of isotactic polypropylene in parts by mass, 0.1-10% of a polypropylene-polybutene-1 block copolymer in parts by mass, 35-95.9% of isotactic polybutene-1 of a medium molecular weight in parts by mass, and 3-15% of isotactic polybutene-1 of a high molecular weight in parts by mass.

2. The isotactic polybutene alloy according to claim 1, wherein a weight-average molecular weight of the isotactic polybutene-1 of the medium molecular weight is 0.2-1 million, and the weight-average molecular weight of the isotactic polybutene-1 of the high molecular weight is 1.1-2 million.

3. The isotactic polybutene alloy according to claim 1, wherein the weight-average molecular weight of the isotactic polypropylene is 0.2-0.8 million, with the isotacticity greater than 95%; the isotacticity of the isotactic polybutene-1 is greater than 95%; the isotacticity of the polypropylene-polybutene-1 block copolymer is greater than 95%; and the mole content of a propylene unit in the block copolymer is 40-70%.

4. The isotactic polybutene alloy according to claim 1, wherein the isotactic polybutene-1 of the high molecular weight is used for improving the high temperature blasting resistance and high temperature hydrostatic resistance of the isotactic polybutene alloy.

5. The isotactic polybutene alloy according to claim 1, wherein the isotactic polybutene alloy has a vicat softening temperature of 115-120° C. tested using an A50 method, and the blasting pressure, hydrostatic resistance and creep resistance of a polybutene-1 alloy tube prepared therefrom, tested at 95° C., is higher than that of a polybutene-1 tube.

6. A preparation method of the high temperature blasting resistance isotactic polybutene alloy, comprising the following steps:
(1) carrying out pump drainage with a polymerization reactor and high-purity nitrogen replacement for times, and sequentially adding propylene and/or an inert solvent with 5-10 carbon atoms, aluminium alkyl, an external donor, a supported titanium catalyst and hydrogen into the polymerization reactor by using a mass flowmeter, wherein the mass ratio of the propylene to the inert solvent is 1:(0-100), the mole ratio of the propylene to the titanium element in the supported titanium catalyst is (0.001*10⁸-1*10⁸):1, the mole ratio of the aluminium element in the aluminium alkyl to the titanium element in the supported titanium catalyst is (10-200):1, the mole ratio of the external donor to the titanium element is (5-25):1, the mole ratio of the hydrogen to the propylene is 1:(50-600), the polymerization temperature is controlled to 0-80° C., the stirring rotation speed is 5-500 rpm, and the polymerization time is 0.01-3 h, thereby carrying out propylene polymerization;
(2) when the polymerization time of the reaction system reaches any time point of the 0.01-3 h, depressurizing to remove remaining propylene monomer, hydrogen or/and inert solvent, so as to obtain active polypropylene granules;
(3) sequentially adding butene-1, aluminium alkyl and hydrogen into the polymerization reactor with the active polypropylene granules, wherein the mole ratio of butene-1 to the titanium element in the supported titanium catalyst is (0.001*10⁷-1*10⁷):1, the mole ratio of the aluminium element to the titanium element in the supported titanium catalyst is (10-200):1, the mole ratio of hydrogen to butene-1 is 1:(700-1300), the polymerization time is 0.1-2 h, and the polymerization temperature is 0-60° C.;
(4) when the polymerization time of the reaction system reaches any time point of the 0.1-2 h, adding hydrogen into the polymerization reactor, wherein the mole ratio of hydrogen to butene-1 is 1:(100-600), the polymerization time is 0.1-46 h, and the polymerization temperature is 0-60° C.; and
(5) when the polymerization time of the reaction system reaches any time point of the 0.1-46 h, depressurizing to remove unreacted butene-1 monomer and hydrogen, thereby obtaining the isotactic polybutene alloy.

7. The preparation method according to claim 6, wherein the aluminium alkyl is a mixture of triethylaluminium (TEA) and triisobutylaluminium, diethylaluminium hydride, diisobutylaluminium, dimethylaluminum chloride, diethylaluminum chloride and diisobutylaluminum chloride, the mass content of triethylaluminium (TEA) in the mixture is 80-100%.

8. The preparation method according to claim 6, wherein the polymerization reactor is equipped with a gas phase reflux unit, for cooling and turning back an upper-layer gas to a liquid phase system of the polymerization reactor; the stirring shaft and blades of the polymerization reactor are equipped with hydrogen feeding pipelines and vents, to disperse a gas phase at the upper part of the polymerization reactor into the liquid phase through the pipelines and vents, thereby maintaining homogeneous distribution of the hydrogen concentration of the whole polymerization system.

9. The preparation method according to claim 6, wherein the titanium element in the supported titanium catalyst accounts for 1-5% of the total mass of the supported titanium catalyst, and the internal donor accounts for 0.5-20% of the total mass of the supported titanium catalyst; one of magnesium chloride, magnesium bromide, magnesium iodide or silicon dioxide is adopted as the supporter for the supporting; and the external donor is one or more of cyclohexyl trimethoxy silane, tert-butyl trimethoxy silane, tert-hexyl trimethoxy silane, diisopropyl dimethoxy silane, cyclohexyl dimethoxy methyl silane, diphenyl dimethoxy silane, tert-butyl-methoxy-dimethyl silane, dimethoxy dicyclopentyl silane, 2-ethyl piperidyl-2-tert-butyl dimethoxy silane, 1,1,1-trifluoropropyl-2-ethyl piperidyl-dimethoxy silane, ethyl trimethoxy silane, trimethoxy propyl silane, phenyl trimethoxy silane and dicyclohexyl dimethoxy silane.

10. The preparation method according to claim 9, wherein the titanium is one of titanium tetrachloride, titanium tetrabromide or titanium tetraiodide containing titanium elements; and the internal donor is one or more of benzoic acid, p-methoxybenzoic acid, p-ethoxybenxoic acid, phenylacetic acid, diisobutyl phthalate, dibutyl phthalate, benzoquinone, methyl benzoate, ethyl benzoate and 9,9-bi(methoxy-methyl) fluorene.

11. A preparation method of the high temperature blasting resistance isotactic polybutene alloy, comprising the following steps:
(1) carrying out pump drainage with a polymerization reactor and high-purity nitrogen replacement for times, and sequentially adding butene-1, aluminium alkyl, an external donor, a supported titanium catalyst and hydrogen into the polymerization reactor by using a mass flowmeter, wherein the mole ratio of the butene-1 to the titanium element in the supported titanium catalyst is (0.001*10⁸-1*10⁸):1, the mole ratio of the aluminium element to the titanium element in the supported titanium catalyst is (10-500):1, the mole ratio of the external donor to the titanium element is (5-25):1, the mole ratio of the hydrogen to the butene-1 is 1:(100-600), the polymerization temperature is controlled to 0-40° C., the stirring rotation speed is 5-500 rpm, and the polymerization time is 0.1-46 h;
(2) when the polymerization time of the reaction system reaches any time point of the 0.1-46 h, adding a butene-1 monomer into the polymerization reactor, and regulating the mole ratio of hydrogen to butene-1 to 1:(700-1300), the polymerization time to 0.1-2 h, and the polymerization temperature to 0-60° C.;
(3) when the polymerization time of the reaction system reaches any time point of the 0.1-2 h, depressurizing to remove unreacted butene-1 and hydrogen, so as to obtain active polybutene-1 granules;
(4) sequentially adding propylene, aluminium alkyl and hydrogen into the polymerization reactor, wherein the mole ratio of propylene to the titanium element in the supported titanium catalyst is (0.001*10⁸-1*10⁸):1, the mole ratio of the aluminium element in the aluminium alkyl to the titanium element in the supported titanium catalyst is (0-100):1, the mole ratio of hydrogen to propylene is 1:(50-600), the polymerization temperature is controlled to 0-80° C., the stirring rotation speed is 5-500 rpm, and the polymerization time is 0.01-3 h; and
(5) when the polymerization time of the reaction system reaches any time point of the 0.01-3 h, depressurizing to remove unreacted monomers and hydrogen, thereby obtaining the isotactic polybutene alloy.

12. The preparation method according to claim 11, wherein the aluminium alkyl is a mixture of triethylaluminium (TEA) and triisobutylaluminium, diethylaluminium hydride, diisobutylaluminium, dimethylaluminum chloride, diethylaluminum chloride and diisobutylaluminum chloride, the mass content of triethylaluminium (TEA) in the mixture is 80-100%.

13. The preparation method according to claim 11, wherein the polymerization reactor is equipped with a gas phase reflux unit, for cooling and turning back an upper-layer gas to a liquid phase system of the polymerization reactor; the stirring shaft and blades of the polymerization reactor are equipped with hydrogen feeding pipelines and vents, to disperse a gas phase at the upper part of the polymerization reactor into the liquid phase through the pipelines and vents, thereby maintaining homogeneous distribution of the hydrogen concentration of the whole polymerization system.

14. The preparation method according to claim 11, wherein the titanium element in the supported titanium catalyst accounts for 1-5% of the total mass of the supported titanium catalyst, and the internal donor accounts for 0.5-20% of the total mass of the supported titanium catalyst; one of magnesium chloride, magnesium bromide, magnesium iodide or silicon dioxide is adopted as the supporter for the supporting; and the external donor is one or more of cyclohexyl trimethoxy silane, tert-butyl trimethoxy silane, tert-hexyl trimethoxy silane, diisopropyl dimethoxy silane, cyclohexyl dimethoxy methyl silane, diphenyl dimethoxy silane, tert-butyl-methoxy-dimethyl silane, dimethoxy dicyclopentyl silane, 2-ethyl piperidyl-2-tert-butyl dimethoxy silane, 1,1,1-trifluoropropyl-2-ethyl piperidyl-dimethoxy silane, ethyl trimethoxy silane, trimethoxy propyl silane, phenyl trimethoxy silane and dicyclohexyl dimethoxy silane.

15. The preparation method according to claim 14, wherein the titanium is one of titanium tetrachloride, titanium tetrabromide or titanium tetraiodide containing titanium elements; and the internal donor is one or more of benzoic acid, p-methoxybenzoic acid, p-ethoxybenxoic acid, phenylacetic acid, diisobutyl phthalate, dibutyl phthalate, benzoquinone, methyl benzoate, ethyl benzoate and 9,9-bi(methoxy-methyl) fluorene.
